(19) United States
(12) Patent Application Publication
(10) Pub. No.: US 2004/0128125 A1
(43) Pub. Date: Jul. 1, 2004

(54) Variable rate speech codec

(75) Inventors: Jari Makinen, Tampere (FI); Pasi Ojala, Lempaala (FI)

Correspondence Address: Crawford Maunu PLLC, Suite 390, 1270 Northland Drive, St. Paul, MN, 55120, US

(73) Assignee: Nokia Corporation

(21) Appl. No.: 10/699,431

(22) Filed: Oct. 30, 2003

(30) Foreign Application Priority Data
Oct. 31, 2002 (FI) 20021936

(51) Int. Cl. G10L 19/04

(52) U.S. Cl. 704/219

(57) ABSTRACT

A method for performing variable rate speech coding in the speech codec comprising a plurality of speech codec modes operating at different bit rates, the speech encoded by said speech codec being arranged for transmission in a telecommunications network. Information on an active speech codec mode set to be supported is received from the telecommunications network, in response to which the supported speech codec modes that correspond to the active codec mode set determined in the telecommunications network will be activated. Thereafter, speech signals to be applied to the speech codec are encoded with the activated speech codec modes such that the speech codec mode of the substantially lowest bit rate is adapted to the speech frames comprised by the speech signals such that in view of the channel conditions in the telecommunications network the level of residual error in coding will be substantially minimized at the same time.

### FIELD OF THE INVENTION

The present invention relates to speech coding, in particular to performing variable rate speech coding.

### BACKGROUND OF THE INVENTION

In wireless digital data transmission, analogue speech information is to be coded into digital format prior to transmission, and thereafter, secured with channel coding in order to be able to ensure a sufficiently good audio quality at signal reception. For instance, the GSM system employs two full-rate speech codecs and one half-rate speech codec. The output bit rates of the full-rate speech codecs are either 13 or 12.2 kbit/s, whereas the half-rate speech codec has an output bit rate of 5.6 kbit/s. These output bits depicting encoded speech parameters are applied to a channel coder. The conventional GSM codecs have a fixed division between speech and channel coding bit rates, irrespective of the quality level of the channel. This approach, which is rather inflexible as to optimising the desired speech quality and on the other hand the capacity of the system, has given rise to the development of an AMR (Adaptive Multi-Rate) codec.

The AMR codec adapts the division of speech and channel coding bit rates to the quality of the channel so as to ensure the best possible overall quality of speech. The AMR codec was first developed to provide a narrowband codec (AMR-NB) particularly applicable to the GSM system and later on a wideband codec (AMR-WB) particularly but not solely applicable to the third generation mobile systems. The AMR speech encoder is a multi-rate integrated speech codec, whose narrowband version AMR-NB comprises eight bit rates within the range of 4.75 to 12.2 kbit/s for audio samples and a low-rate background noise generation mode (DTX), and correspondingly, the wideband version AMR-WB comprises nine bit rates within the range of 6.6 to 23.85 kbit/s for audio samples and also a low-rate background noise generation mode.

The terminals, such as GSM mobile stations, using the narrowband AMR-NB codec should support all eight bit rates, i.e. the codec mode. However, the base station of each cell supports only some of these codec modes, i.e. a so-called active codec mode set, which may vary in handover from one cell to another. Correspondingly, the terminals using the wideband codec AMR-WB should support all nine codec modes, but the base stations support only some of them.

In systems employing the AMR codec, the codec mode is selected such that the channel quality will be optimised. Systems, such as the IS-95 system, are also known, in which the speech codec mode to be used is selected from all the modes on the basis of speech quality information. The speech quality is evaluated on a continuous basis during the call by means of given parameter values, and if the parameter values exceed predetermined limit values, the codec mode will be changed according to a mode selection algorithm. This codec mode selection based on the speech quality information would also make it possible for the AMR codec to achieve more efficient speech compression than currently, at least in some situations.

In that case, the above-described change of active codec modes poses a problem, for instance, in handover from one cell to another, or due to a cell-specific codec mode set change. The mode selection algorithm of a terminal may provide for use a codec mode that the base station of said cell does not support. This results in deterioration of speech quality or in interference between terminals, because the bit rate of the terminals remains excessively high. Hence, in a situation like this it is impossible to use a system-wide mode selection algorithm.

### BRIEF SUMMARY OF THE INVENTION

It has now been invented an improved method and equipment implementing the method for avoiding at least some of the above-mentioned problems. This is achieved with a method and equipment, which are characterized by what is disclosed in the independent claims.

Some embodiments of the invention are disclosed in the dependent claims.

The invention is based on the idea that in a speech codec, comprising a plurality of speech codec modes operating at different bit rates and speech encoded by said speech codec being arranged for transmission in a telecommunications network, variable rate speech coding is performed such that information on an active codec mode set to be supported is received from the telecommunications network, in response to which, the speech-codec-supported speech codec modes that correspond to the active codec mode set determined in the telecommunications network will be activated. Thereafter, speech signals to be applied to the speech codec are encoded with said activated speech codec modes such that a speech codec mode of the substantially lowest bit rate is adapted to speech frames comprised by the speech signals such that, in view of the channel conditions in the telecommunications network, the level of residual error in coding will be minimized at the same time.

In this manner, the mode selection algorithm advantageously takes into account the codec modes supported by the network and used at any particular time, whereby the codec mode selection seeks optimal adaptation such that the average channel bit rate set by the network will not be exceeded, and at the same time, the bit rate of speech coding will be minimized. An advantage achieved thereby is to make sure that the speech codec will have a codec mode that the base station of said cell supports and at the same time the network capacity will be increased and the average transmission power will be reduced, maintaining a sufficient speech quality for a decoded speech signal, however.

According to an embodiment, the parameters to be used in the speech codec mode selection and the limit values thereof are adaptive such that responsive to changes in the channel conditions in the telecommunications network and/or in the active codec mode set, the parameters to be used in the speech codec mode selection and the limit values thereof are adapted to correspond to new channel conditions in the telecommunications network and/or to the active codec mode set. Thus, the method of the invention advantageously takes into account the change of the active codec mode, for instance, in handover from one cell to another, or due to the change of the cell-specific codec mode set.

Also, according another embodiment, in the speech codec mode selection the target level of residual error in coding and the bit rate of the codec mode to be selected are advantageously adapted to the average bit rate employed on a traffic channel in the telecommunications network. The minimized bit rate of the speech coding results in a reduced average bit rate of the traffic channel, which is particularly useful in CDMA-based systems.

One aspect of the invention is a variable rate speech codec comprising a plurality of speech codec modes operating at different bit rates and speech encoded by said speech codec being arranged for transmission in a telecommunications network, the speech codec being arranged to receive information from the telecommunications network on an active codec mode set to be supported and to activate the speech codec modes that correspond to the active codec mode set determined in the telecommunications network. The speech codec is also arranged to encode the speech signals to be applied to the speech codec with said activated speech codec modes such that a speech codec mode of the substantially lowest bit rate is arranged for adaption to speech frames comprised by the speech signals such that, in view of the channel conditions in the telecommunications network, the level of residual error in coding will be minimized at the same time.

According to an embodiment, the speech codec comprises means for determining a speech codec mode for a speech frame from among the activated speech codec mode set by determining a speech codec mode of the substantially lowest bit rate, which mode substantially minimizes the level of residual error in the coding at the same time, and means for selecting a speech codec mode for a speech frame from among the activated speech codec mode set by adapting the level of residual error in the coding to be targeted in the selection of the speech codec mode and the bit rate of the selected codec mode to the average bit rate to be used on the traffic channel of the telecommunications network.

The speech codec of the invention can be implemented as software comprising program codes to execute the above-mentioned functions after loading the computer program in a processor for execution.

In addition to the above-mentioned advantages, it is also possible to achieve other advantages with the method of the invention. One advantage is that the adaptation algorithm of speech coding can be implemented in a very simple manner, because the operation of the adaptation algorithm is based on pre-computed parameter values provided by a speech encoder. Advantageously, in that case the complexity of the coding process does not increase considerably and, on the other hand, the codec mode selection can be advantageously performed on the basis of a more accurate estimate. A further advantage is that the amount of memory required by the coding process does not preferably grow.

### BRIEF DESCRIPTION OF THE DRAWINGS AND THE APPENDICES

In the following the invention will be described in greater detail in connection with its preferred embodiments, with reference to the attached drawings, wherein

FIG. 1 shows some essential parts of a radio system employing speech coding according to the invention;

FIG. 2 illustrates as block diagram the functional structure of a coder according to a preferred embodiment of the invention;

FIG. 3 shows an example of speech coding adaptation for a randomly selected speech sequence;

Appendix 1 shows bit allocation of different codec modes of a wide-band speech codec AMR-WB in a table form; and

Appendix 2 shows a program pseudo code of a simplified adaptation algorithm of speech coding.

### DETAILED DESCRIPTION OF THE INVENTION

In the following the invention will be described in greater detail using a 3GPP system, i.e. the so-called UMTS system, as a base to which the embodiments of the invention are advantageously applied. However, the invention is not restricted to the 3GPP system only, but it can be utilized in any corresponding system, in which the speech codec bit rate is to be optimised with respect to the speech quality. Thus, the basic idea of the invention can be applied, for instance, to GSM/EDGE systems, which also support a wideband AMR codec.

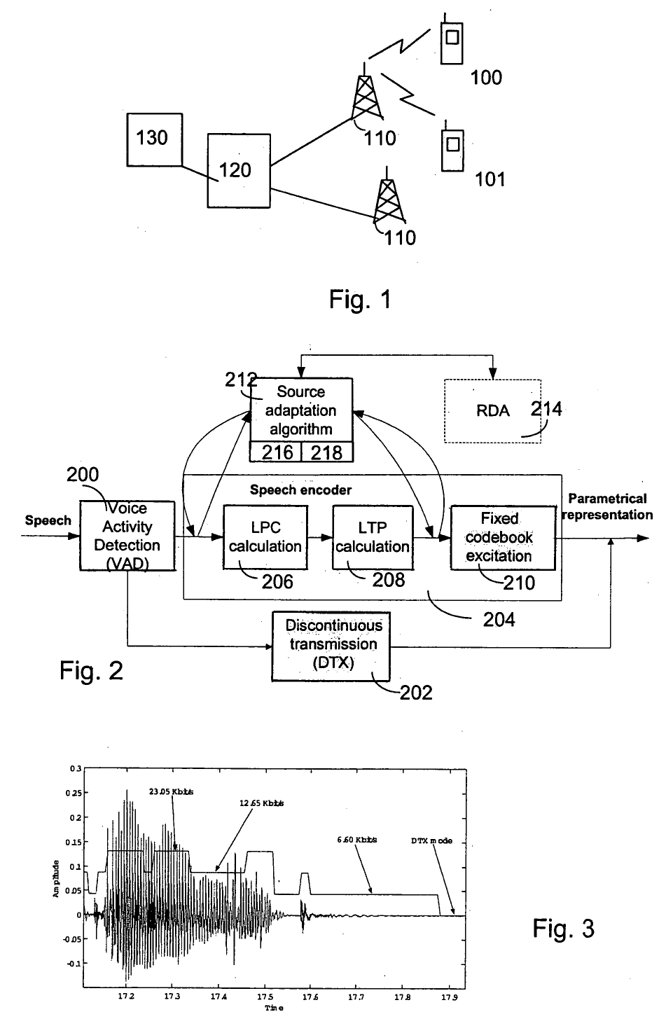

FIG. 1 shows a simplified example of a radio system, in some parts of which the method according to the invention is applied. The described cellular radio network comprises a base station controller 120, base stations 110 and subscriber terminals 100, 101. The base stations 110 and the subscriber terminals 100, 101 serve as transceivers in a cellular radio system. The terminals establish connections to one another by signals, which pass through a base station 110. The subscriber terminal 100 can be a mobile station, for instance, which comprises a speech codec of the invention. A transcoder unit 130, which in turn comprises a network-side speech codec, is arranged in operational connection with the base station controller 120. The radio system shown in FIG. 1 may be a 3GPP (UMTS) system, for instance, and the radio system may use a WCDMA (Wideband Code Division Multiple Access) system, for instance. In addition to said elements, these radio systems comprise a plurality of other elements, which need not be described herein, because the structures of said radio systems are known per se to persons skilled in the art.

The wideband speech codec AMR-WB is further developed from the narrowband speech codec AMR-NB previously developed for the GSM system. Both the wideband and the narrowband AMR codecs are arranged to adapt the level of error concealment to radio channel and traffic conditions such that they always seek to select an optimal channel and a codec mode (speech and channel bit rates) in order to provide the best possible speech quality.

The AMR speech codec consists of a multi rate speech encoder, a source controlled rate diagram, which comprises voice activity detection (VAD) and a background noise generation system (DTX, Discontinuous Transmission) as well as an error concealment mechanism that is to prevent transmission path errors from being transmitted to a receiving party. The multi rate speech codec is an integrated speech codec, whose narrowband version AMR-NB comprises eight speech codecs having bit rates of 12.2, 10.2, 7.95, 7.4, 6.7, 5.9, 5.15 and 4.75 kbit/s. The wideband speech codec AMR-WB, in turn, comprises nine speech codecs with bit rates of 23.85, 23.05, 19.85, 18.25, 15.85, 14.25, 12.65, 8.85 and 6.60 kbit/s.

The speech codecs feed encoded speech parameters to a channel coder, in which successive operations, such as bit reorganisation, calculation of a CRC (Cyclic Redundancy Check) value for some of the bits, convolution coding and puncturing, are performed. Apart from the puncturing, these operations are intended for adding redundancy to the information sequence. The coding is generally performed on a given number of input bits. A better coding efficiency is achieved by increasing the complexity of the coding. However, transmission delays and limited equipment resources restrict the complexity available in real-time applications.

The AMR codecs of the GSM/EDGE system employ dynamic division between bit rates of speech and channel codings such that after channel coding the codec output bit rate always corresponds to the standard rate of the traffic channel used. This allows utilisation of the fact that protection provided by the channel coding depends greatly on the channel quality level. When the channel conditions are good, it is possible to use a lower bit rate of channel coding, which in turn enables the use of a higher bit rate in the speech codec.

In the 3GPP (UMTS) system, the WCDMA system used at the radio interface has a channel coding bit rate that is typically constant for the whole duration of the call and it cannot be changed so quickly as the rate of the AMR speech coding. Therefore, the reduction of the speech codec bit rate also reduces the overall bit rate of the traffic channel and consequently the speech codec mode adaptation can be used for increasing the capacity of the system.

The operation of the speech coding of the AMR speech codecs is based on the ACELP (Algebraic Codebook Excited Linear Prediction) method. The wideband codec AMR-WB samples speech at the frequency of 16 kHz, whereafter the pre-processed speech signal is down sampled to the operating frequency 12.8 kHz of the codec. This enables a 6.4 kHz bandwidth for a decoded speech signal, but the codec mode operating at the highest bit rate of 23.85 kbit/s also comprises speech signal post-processing functions, by means of which it is possible to determine for the speech signal a coloured random noise component in a higher frequency range (6.4 to 7 kHz) that increases the bandwidth used to 7 kHz. The output bit stream of the speech encoder thus consists of encoded speech parameters that are typical ACELP encoder parameters. These include LPC (Linear Predictive Coding) parameters quantised in an ISP (Immitance Spectral Pair) domain, describing the spectral content and defining short-term coefficients of the filters;

LTP (Long Term Prediction) parameters describing the periodic structure of speech;

ACELP excitation describing the residual signal after linear predictors;

signal gain;

a gain parameter of extended high frequency band (only to be used in the codec of the highest bit rate).

These speech parameters are transmitted channel coded to a decoder, which decodes the channel coding and decodes the speech parameters thus forming an audio signal to be reproduced in a receiver. Along with the speech parameters, information on the codec mode to be used is also transmitted to the decoder, because the decoding of the LPC and LTP parameters and of the signal gain depends on the codec mode used. In addition, information defining the voice activity detection (VAD) is also transmitted, which enables improved operation of error hiding mechanism in the decoder.

The table of Appendix 1 describes bit allocation of different codec modes of the wideband speech codec AMR-WB with respect to the above-mentioned parameters for one 20 ms speech frame. For encoding, the 20 ms speech frame is divided into four 5 ms sub-frames. The LPC and LTP parameters and the signal gain are determined to be the most important, i.e. class A, parameters. It can be seen from the table of Appendix 1 that the number of bits in these parameters are identical in all codec modes, except for the two codec modes of the lowest bit rate (6.6 and 8.85 kbit/s). Thus, for higher codec modes (12.65 to 23.85) differences in the number of bits in the whole speech frame only result from the differences in the bits of the algebraic code-book used. In other words, in the codec mode of 12.65 kbit/s less pulses, i.e. a lower coding resolution, are used for generating an excitation signal than in the codec mode of 23.05 kbit/s, for instance, which appears as a smaller number of bits. In addition, for the codec of the highest bit rate (23.85 kbit/s) is calculated a gain parameter of an extended higher frequency band, which provides the speech frame with 16 additional bits as compared with the otherwise similarly encoded speech frame of the codec mode of 23.05 kbit/s. In the codec mode of 8.85 kbit/s the coding resolution of the LPC parameters (ISP) is the same as in the higher codec modes, but the other parameters are encoded with poorer resolution. In the codec mode of the lowest bit rate of 6.6 kbit/s all the parameters are encoded with lower resolution than in the higher codec modes.

The better the resolution, i.e. the higher the bit rate, by which the speech parameters are encoded (i.e. the better the quantisation of the speech parameters), the lower the average residual error between perceptually weighted original and synthesized speech. An average low residual error level does not mean, however, that each speech frame would attain the lowest residual error level even when encoded at the highest bit rate. It is also possible to prove that some speech frames attain the best coding result with the codec mode of the lowest bit rate (6.6 kbit/s).

Table 1 here below illustrates a test situation, in which speech coding is performed on one-minute speech sequence with all codec modes of the wideband speech codec AMR-WB, whereafter percentages have been determined of all speech frames, in which each codec mode has achieved its best coding result, i.e. the lowest residual error level.

TABLE 1

| | Usage based on |
|---|---|
| Mode | minimum residual error |
| 6.6 kbit/s | 3% |
| 8.85 kbit/s | 2% |
| 12.65 kbit/s | 5% |
| 14.25 kbit/s | 7% |
| 15.85 kbit/s | 10% |
| 18.25 kbit/s | 18% |
| 19.85 kbit/s | 23% |
| 23.05/23.85 Kbit/s | 34% |
| | 100% |

Even though the one-minute speech sequence used in the test is selected quite randomly, it substantially appears from Table 1 that also the codec modes of the lowest bit rate achieve the best coding result at least for a few percent of the speech frames. In addition, Table 1 shows a clear trend that the higher the bit rate used, the higher the percentage of the speech frames having the best coding result, however, in such a way that the percentage of the codec mode having the highest bit rate is substantially not more than a third. On the other hand, it is also possible to prove that the bit rate used in the codec modes and the resulting number of relative coding errors in the excitation signal after linear predictions correlates strongly with the decoded speech quality. It is possible to prove that during transient speech sequences in particular the performance of the codec modes of the two lowest bit rates (6.6 and 8.85 kbit/s) is insufficient for coding of good quality.

These observations have been utilized in the speech codec of the invention, whose operation will be described in the following with reference to the block diagram of FIG. 2. FIG. 2 describes the functional structure of a wideband speech codec AMR-WB, in which speech codec input speech is first applied to a voice activity detection block (VAD) 200. In this block, an operation is performed on the input signal by means of the VAD algorithm, in which frames that comprise speech components are separated from the frames that only comprise noise. A preliminary VAD parametrization is performed on the frames comprising speech components, whereas the frames comprising only noise will be directed to bypass the speech encoder to a discontinous transmission (DTX) block 202, which encodes the frames comprising noise at a low bit rate (1.75 kbit/s).

The speech frames comprising speech components are applied to a speech encoder 204, which comprises functionalities known per se for computing LPC parameters (block 206), LTP parameters (block 208) and parameters depicting signal gain (block 210). In addition, the codec comprises a speech coding adaptation algorithm 212, which determines the most suitable speech codec mode for each speech frame separately, if necessary, trying to find a codec mode of as low a bit rate as possible, however, with the proviso that the speech quality will not substantially deteriorate. Further, the codec comprises a rate determination algorithm 214, which selects the final codec mode on the basis of, on one hand, the codec mode suggested by the speech coding adaptation algorithm and, on the other hand, the average channel bit rate set by the network, between which the rate determination algorithm seeks optimal adaptation such that the average channel bit rate set by the network will not be exceeded and at the same time the bit rate of speech coding will be minimized.

The network capacity is thus increased and the average transmission power is reduced, retaining a sufficient speech quality for the decoded speech signal, however. The minimized bit rate of the speech coding results in a reduced average bit rate of the traffic channel, which is particularly advantageous in CDMA-based systems.

The operation of the speech coding adaptation algorithm 212 is based on pre-calculated parameter values provided by the speech encoder 204, thanks to which the adaptation algorithm can be implemented in a very simple manner, which does not advantageously add to the complexity of the coding process to any considerable degree. The operation of the adaptation algorithm is mainly based on the information obtainable in computed parameter values from the above-described VAD, LPC and LTP processes. Thus, advantageously the amount of memory required by the coding process does not grow either.

The speech coding adaptation algorithm comprises two separate function routines: a selection of a low mode 216 and a control of a higher mode 218. The first function routine, the selection of the low mode 216, is performed in the functional structure of the speech codec after the VAD process 200 but prior to the LPC parameter calculation 206. Thus the selection of the low mode mainly utilizes the results of the speech frame VAD parametrization. The purpose of the low mode selection algorithm is to identify the frames that could use the codec modes of a low bit rate, either 6.6 or 8.85 kbit/s, without the speech quality suffering from low coding resolution. Because the representation formats of the LPC and LTP parameters of both of these modes differ from those of the higher codec modes, in accordance with Appendix 1, a decision on the possible use of these modes must be made before starting to determine LPC and LTP parameters for a speech frame. The VAD processing gives as a result speech frames, or sequences thereof, which allow determination of a frequency band and energy used in speech. If speech frames, or sequences thereof, are found, where the energy used in speech is very low, it is possible to encode these speech frames advantageously with the lowest bit rate 6.6 kbit/s. Whereas, if speech frames, or sequences thereof, are found, where the energy used in speech is relatively low and the frequencies used are very low, it is possible to encode these frames to good effect at the bit rate of 8.85 kbit/s. The criteria and limit values, e.g. for speech energy, used in the codec mode selection, can advantageously be determined for the speech coding adaptation algorithm adaptively such that the average bit rate is taken into account in the determination of limit values. The speech frames that do not meet the criteria of the low mode selection should be encoded with a higher bit rate codec, whereby the speech coding adaptation algorithm proceeds to a higher mode control 218.

In the higher mode control a codec mode of as low a bit rate as possible is to be selected for a speech frame, or a sequence thereof, from among the higher codec modes (12.65 to 23.85) without that the speech quality deteriorates. Also in the higher mode control the selection of the codec mode is primarily based on analyzing the frequency band and energy used in speech. In addition to that, the mode selection utilizes the LTP parameters and signal gain parameters calculated in the speech encoder. Hence, the codec mode selection can advantageously be carried out on the basis of a more accurate estimate, because the codec mode selection may utilize the information on the speech frame obtained during the speech coding.

According to one preferred embodiment of the invention the speech coding adaptation algorithm classifies the speech sequences to be encoded according to speech characteristics into a plurality of different classes, on the basis of which the selection of a suitable codec mode is made. In defining the speech sequence classes it is possible to use data analysed from the speech frames, such as spectral content, gains of different parameters, zero cross rate of a speech signal and its standard deviation, mutual correlation of successive speech frames, etc. The classes may include, for instance, a low energy sequence, a transient sequence, a voiced speech sequence and an unvoiced speech sequence. Thus, the low energy sequence, for instance, can be coded with a low bit rate codec mode without degradation in the speech quality. On the other hand, the speech quality of the transient sequence degrades rapidly if a low bit rate codec mode is used, and therefore it is necessary to use a higher codec mode for the transient sequence. The coding of the voiced and the unvoiced speech sequences depends substantially on the speech frequencies. For instance, the voiced low-frequency sequences can be coded to good effect even with a low bit rate, whereas the unvoiced sequences resembling noise require a high bit rate. It is apparent to a person skilled in the art that speech sequence characteristics can also be classified according to various other criteria and the formed classes may thus differ from those described above.

As described above, a mobile station employing the AMR codec must be provided with all the codec modes. However, the network may support any combination thereof. When the AMR is used, the codec mode is selected from the active codec mode set (ACS), which set may comprise 1 to 4 AMR codec modes. This set can be re-determined in a call setup phase, in a handover situation or by means of RATSCCH signalling. The active codec mode set may change during handover from one cell to another. Further, when traffic is heavy, a network operator may set the active codec mode set of given cells such that only codec modes of lower bit rates are available, which increases the capacity of the network. Correspondingly, outside the heavy traffic hours the active codec mode set can be changed such that the same cells also support codec modes of higher bit rates. In addition, it should be noted that if a circuit-switched call connection uses tandem-free operation (TFO) or transcoder-free operation (TrFO), the network settings at both ends of the call connection concerning the codec mode set have to be taken into account.

Naturally, these network constraints on the available codec modes have to be taken into account in the speech coding adaptation algorithm 212 and, in particular, in the rate determination algorithm 214. The network provides the speech codec of the mobile station with information on the active codec mode set supported by the base station at any given time. In addition, the network provides the rate determination algorithm 214 with an average channel bit rate, indicating the quality of the traffic channel, for which the rate determination algorithm seeks to select a suitable speech codec mode in view of the most suitable codec modes determined by the adaptation algorithm. Because the active codec mode set may change during the call connection, the rate determination algorithm must be adaptable such that the codec mode to be used is selected from the new, post-change active codec mode set. In addition, because the speech power level and the background noise vary as a function of time, these changes must also be taken into account, as the codec mode is adapted to the average bit rate of the channel.

The average bit rate of a traffic channel may also vary as a function of time, for instance, when the terminal is moving within the network area to a coverage area where traffic is heavier. In that case, the network tries to adapt capacity, as a result of which the average bit rate of the channel typically reduces, whereby the bit rate of speech coding should also be adapted to the new bit rate of the traffic channel. The reduction of the speech coding bit rate often results in an increase in the lowest achievable residual error level, in other words, as the average channel bit rate reduces, typically the best possible coding result also reduces. Hence, the average bit rate of the traffic channel is a dynamically changing variable, according to the value of which the residual error level of coding will substantially be minimized. Correspondingly, the lowest achievable residual error level controls the selection of the codec mode. Thus, the criteria and the limit values controlling the selection of the codec mode of the rate determination algorithm must also be adaptive.

Advantageously, the speech coding adaptation algorithm also takes into account the active codec mode set used at any given time such that both function routines, the low mode selection 216 and the higher mode control 218, take into account the codec modes belonging to both function routines, determined in the active codec mode set. Hence, in the low mode selection it is first checked whether either one of the codec modes of the lowest bit rate (6.6 or 8.85 kbit/s) belongs to the active codec mode set. If neither one of these codec modes is determined to be in the codec mode set, the adaptation algorithm omits the function routine of the low mode selection and proceeds directly to the higher mode control. Correspondingly, if none or only one codec mode of higher bit rate (12.65 to 23.85 kbit/s) has been determined to be in the active codec mode set, the function routine of the higher mode control will be omitted. Naturally, this is also the case when in the low mode selection either one of the codec modes of a low bit rate (6.6 or 8.85 kbit/s) has already been selected.

FIG. 3 shows an example of speech coding adaptation in a situation, where the active codec mode set comprises three codec modes: 6.6, 12.65 and 23.05 kbit/s. FIG. 3 shows the energy of the speech sequence returned as a function of time and the codec modes used for encoding the speech sequence. As appears from FIG. 3, at the beginning of the speech sequence the codec modes vary between 23.05 and 12.65 kbit/s. The end portion of the speech sequence comprises a long, low-energy speech signal and its coding with a codec mode of a low bit rate (6.6 kbit/s) produces a considerably lower average bit rate than the prior art speech coding, in which the codec mode is selected according to channel conditions and the speech sequence of FIG. 3 would probably be encoded with one codec mode. The use of DTX mode for encoding low-energy speech signals is not advisable, because it causes audible breaks in the speech signal.

The length of the speech sequence in FIG. 3 is less than one second. As described above, each 20 ms speech frame can be encoded with a different codec mode, if necessary, so even minor changes in the signal level can be taken into account in the selection of the codec mode. It is possible to alternate the use of all codec modes belonging to the active codec mode set without L3-layer signalling, which enables quick transition between the modes as the speech signal changes.

The above-described operations according to the invention are only associated with the speech coding process, in which phases that can be decoded in a manner known per se will be implemented in a novel manner. Thus, the method of the invention does not affect the operation of the decoder per se but the speech encoded with the above-described method can advantageously be decoded with a prior art AMR decoder.

It should be noted that the functional elements of the above-described speech codec and the related functional phases, such as the speech coding adaptation algorithm and the rate determination algorithm, according to the invention can advantageously be implemented as software, hardware or a combination thereof. The speech coding of the invention is particularly well suited for computer software implementation, which comprises computer-readable commands for controlling digital signal processing DSP and for executing the functional steps of the invention, for instance. Advantageously the speech coding can be implemented as a program code stored on a storage medium and executed with a computer-like device, such as a personal computer (PC) or a mobile station, for providing speech coding functions with said device. Further, the speech coding functions of the invention can be loaded on the computer as a software update, whereby the functions according to the invention can already be produced in the known devices.

Appendix 2 shows a simplified example how to implement a speech coding algorithm by means of a program pseudo code. The algorithm works for each speech frame. The active codec mode set (active_speech_mode_set) and three codec modes of different rates (low_mode, middle_mode, high_mode) belonging thereto are determined at the beginning of the algorithm. For the sake of clarity, LPC or LTP parameters are not used in the mode selection in this simplified example, but the mode selection is simply carried out by means of the speech power level and the background noise and the gain of a fixed codebook. Specific limit values (low_gain_threshold, high_gain_threshold), which are further utilized in the mode selection, are determined on the basis of these parameters. The codec mode of the highest bit rate (high_mode) is used for coding transient, unvoiced and some voiced speech sequences. The codec mode of the lowest bit rate (low_mode) is used for coding low energy speech sequences. The speech sequences that do not meet the above-mentioned criteria are coded with the middlemost codec mode (middle_mode).

It is apparent to a person skilled in the art that as technology progresses the basic idea of the invention can be implemented in a variety of ways. Thus, the invention and its embodiments are not restricted to the above-described examples but they may vary within the scope of the attached claims.

What is claimed is:

1. A method for performing variable rate speech coding in a speech codec comprising a plurality of speech codec modes operating at different bit rates and speech encoded by said speech codec being arranged for transmission in a telecommunications network, the method comprising:
receiving information on an active codec mode set to be supported from the telecommunications network;
activating the speech-codec-supported speech codec modes that correspond to the active codec mode set determined in the telecommunications network; and
encoding speech signals to be applied to the speech codec with said activated speech codec modes such that a speech codec mode of the substantially lowest bit rate is adapted to speech frames comprised by the speech signals such that, in view of the channel conditions in the telecommunications network, the level of residual error in coding will be minimized at the same time.

2. A method as claimed in claim 1, further comprising
responsive to changes in at least either of the following: the channel conditions in the telecommunications network, the active codec mode set;
adapting the parameters to be used in the speech codec mode selection and the limit values thereof to correspond to new channel conditions and capacity of the telecommunications network or to the active codec mode set.

3. A method as claimed in claim 1, further comprising
adapting the target level of residual error in coding in the speech codec mode selection and the bit rate of the codec mode to be selected to the average bit rate employed on a traffic channel in the telecommunications network.

4. A method as claimed in claim 1, further comprising
performing at least some of the speech coding sub-processes on the speech frame; and
adapting a speech codec mode for each speech frame on the basis of the parameter values obtained from said sub-processes.

5. A method as claimed in claim 4, wherein
the speech coding is performed as ACELP coding, whereby said sub-processes include at least one of the following:
VAD parametrization process;
LPC parametrization process;
LTP parametrization process;
parametrization process of signal gain.

6. A method as claimed in claim 5, further comprising
determining the speech codec mode in two steps by
adapting a low bit rate speech codec mode for the speech frame, responsive to the parameter values obtained from the VAD parametrization process indicating that the speech frame comprises a low energy speech signal; and
adapting a higher bit rate speech codec mode for the speech frame on the basis of several said parameter values responsive to the speech codec mode of the low bit rate not being adapted for the speech frame.

7. A method as claimed in claim 4, further comprising
classifying the speech frames to be encoded into a plurality of different classes on the basis of the information analysed from the speech frames, which comprises at least some of the following: spectrum of the speech frame, gains of different speech frame parameters, zero cross frequency of the speech signal; and
adapting a speech codec mode for the speech frame on the basis of the class defined for the speech frame.

8. A variable rate speech codec comprising a plurality of speech codec modes operating at different rates and speech encoded by said speech codec being arranged for transmission in a telecommunications network, the speech codec being arranged
to receive information from the telecommunications network on an active codec mode set to be supported;
to activate the speech codec modes that correspond to the active codec mode set determined in the telecommunications network; and
to encode the speech signals to be applied to the speech codec with said activated speech codec modes such that a speech codec mode of the substantially lowest bit rate is arranged for adaption to speech frames comprised by the speech signals such that, in view of the channel conditions in the telecommunications networks, the level of residual error in coding will be minimized at the same time.

9. A speech codec as claimed in claim 8, the speech codec comprising
means for determining a speech codec mode for a speech frame from among the activated speech codec mode set by determining a speech codec mode of the substantially lowest bit rate, which mode substantially minimizes the level of residual error in coding at the same time, and
means for selecting a speech codec mode for a speech frame from among the activated speech codec mode set by adapting the level of residual error in the coding to be targeted in the speech codec mode selection and the bit rate of the selected codec mode to the average bit rate to be used on the traffic channel of the telecommunications network.

10. A speech codec as claimed in claim 9, wherein responsive to changes in at least either of the following: the channel conditions in the telecommunications network, the active codec mode set
said means for determining the speech codec mode and means for selecting the speech codec mode are arranged to adapt the parameters to be used in the speech codec mode selection and the limit values thereof to correspond to new channel conditions and capacity of the telecommunications network or to the active codec mode set.

11. A speech codec as claimed in claim 8, wherein the speech codec is arranged
to perform at least some of the sub-processes of the speech coding; and
to adapt a speech codec mode for each speech frame on the basis of the parameter values obtained from said sub-processes.

12. A speech codec as claimed in claim 11, wherein
the speech coding is arranged to be performed as ACELP coding, whereby the speech codec comprises at least one of the following:
means for performing a VAD parametrization process;
means for performing an LPC parametrization process;
means for performing an LTP parametrization process;
means for performing a signal gain parametrization process.

13. A speech codec as claimed in claim 12, wherein
the speech codec is arranged to determine the speech codec mode in two steps, whereby the speech codec comprises
means for adapting a low bit rate speech codec mode for the speech frame responsive to the parameter values obtained from the VAD parametrization process indicating that the speech frame comprises a low energy speech signal; and
means for adapting a higher bit rate speech codec mode for the speech frame on the basis of several said parameter values responsive to the speech codec mode of the low bit rate not being adapted for the speech frame.

14. A mobile station comprising a variable rate speech codec comprising a plurality of speech codec modes operating at different bit rates, the speech encoded by the speech codec being arranged for transmission in a telecommunications network, the speech codec being arranged
to receive information from the telecommunications network on the active codec mode set to be supported;
to activate the speech-codec-supported speech codec modes that correspond to the active codec mode set determined in the telecommunications network; and
to encode speech signals to be applied to the speech codec with said activated speech codec modes such that a speech codec mode of the substantially lowest bit rate is adapted to speech frames comprised by the speech signals such that, in view of the channel conditions in the telecommunications network, the level of residual error in coding will be minimized at the same time.

15. A computer program, when loaded in a processor, being arranged to implement variable rate speech codec functions, the speech codec comprising a plurality of speech codec modes operating at different bit rates, the speech encoded by the speech codec being arranged for transmission in a telecommunications network, the computer program comprising
a program code for receiving from the telecommunications network information that determines the active codec mode set to be supported;
a program code for activating the speech codec modes that correspond to the active codec mode set determined in the telecommunications network;
a program code for encoding the speech signals to be applied to the speech codec with said activated speech codec modes such that a speech codec mode of the substantially lowest bit rate is arranged for adaption for speech frames comprised by the speech signals such that, in view of the channel conditions in the telecommunications network, the level of residual error in coding will be minimized at the same time.

16. A computer program as claimed in claim 15, further comprising
a program code for determining a speech codec mode for a speech frame from among the activated speech codec mode set by determining a speech codec mode of the substantially lowest bit rate, which mode substantially minimizes the level of residual error in the coding at the same time, and
a program code for selecting a speech codec mode for a speech frame from among the activated speech codec mode set by adapting the level of residual error in the coding to be targeted in the speech codec mode selection and the bit rate of the selected codec mode to the average bit rate to be used on the traffic channel of the telecommunications network.
